(19) United States
(12) Patent Application Publication
(10) Pub. No.: US 2011/0128748 A1
(43) Pub. Date: Jun. 2, 2011

(54) METHOD OF CONTROLLING ADAPTIVE HEADLAMP

(75) Inventors: Sung Uk Choi, Hwaseong-si (KR); Hun Soo Kim, Bucheon-si (KR); Hee Jun Jeong, Hwaseong-si (KR); Se Wook Oh, Gunpo-si (KR); Hyun-Soo Lee, Yongin-si (KR)

(73) Assignees: Hyundai Motor Company, Seoul (KR); Hyundai Mobis, Seoul (KR)

(21) Appl. No.: 12/835,379

(22) Filed: Jul. 13, 2010

(30) Foreign Application Priority Data
Dec. 1, 2009 (KR) 10-2009-0117986

(51) Int. Cl. B60Q 1/04

(52) U.S. Cl. 362/465

(57) ABSTRACT

A method of controlling an adaptive head lamp including a control unit for detecting a driving signal of a vehicle to control an actuator which controls the head lamp in a horizontal or vertical direction in accordance with a control signal of the control unit, may include steps of, a) verifying whether an ignition of the vehicle is turned on or off, b) after the ignition of the vehicle is verified, driving the actuator to move the head lamp to a rightmost or leftmost position in the horizontal direction, or a lowermost or uppermost position in the vertical direction, c) driving the actuator by a predetermined number of pulses previously set in a micro stepping manner in a direction opposite to a driving direction of the headlamp at the step b), and d) setting a position of the head lamp determined at the step c) as an initial position.

### CROSS-REFERENCE TO RELATED APPLICATION

The present application claims priority to Korean Patent Application No. 10-2009-117986, filed on Dec. 1, 2009, the entire contents of which is incorporated herein for all purposes by this reference.

### BACKGROUND OF THE INVENTION

1. Field of the Invention

The present invention relates to a method of controlling an adaptive head lamp, and more particularly, to a method of controlling an adaptive head lamp which can simplify a closed loop control system and eliminate a feedback sensor.

2. Description of Prior Art

A conventional head lamp 1 shown in FIG. 1 irradiates light only in a fixed direction toward the front of a vehicle, with the head lamp fixed to the vehicle.

When the vehicle turns to the right or left or accelerates, it is difficult for a driver to secure the field of vision only by the fixed head lamp.

An adaptive head lamp has been proposed which can rotate the head lamp by using actuators to adjust horizontal and vertical directions of the head lamp.

The adaptive head lamp is adapted to adjust the horizontal and vertical angles of the head lamp in accordance with driving information such as steering angle or velocity of the vehicle, thereby securing the visual field of the driver.

However, in a case in which the head lamp is wrongly controlled, it may lead to a car accident. Therefore, the confidence in a rotational error comes to the fore as an important problem.

In order to gain the confidence, a closed loop control system has been used which employs a linear feed back system.

However, in the case of employing the control system, since a closed loop with a feedback sensor is added, the control is complicated and the cost is increased, in comparison with an open loop control system. Further, in a case of mounting the feedback sensor on the actuator, it occupies a space, which lowers the degree of freedom in designing. In a case of mounting the feedback sensor on a driving portion between the actuator and the head lamp, an electric connection is required.

In addition, an error in the operation is determined depending upon the mounting accuracy of the feedback sensor, and it is possible to correct the error by the feedback control.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a method of controlling an adaptive head lamp which can simplify a closed loop control system and eliminate a feedback sensor.

In an aspect of the present invention, the method of controlling an adaptive head lamp including a control unit for detecting a driving signal of a vehicle to control an actuator which controls the head lamp in a horizontal or vertical direction in accordance with a control signal of the control unit, may include steps of: a) verifying whether an ignition of the vehicle is turned on or off, b) after the ignition of the vehicle is verified, driving the actuator to move the head lamp to a rightmost or leftmost position in the horizontal direction, or a lowermost or uppermost position in the vertical direction, c) driving the actuator by a predetermined number of pulses previously set in a micro stepping manner in a direction opposite to a driving direction of the headlamp at the step b), and d) setting a position of the head lamp determined at the step c) as an initial position.

The predetermined number of pulses may be defined as the number of pulses for the actuator to move the headlamp between the rightmost or leftmost position and a center portion of the head lamp in the horizontal direction.

The predetermined number of pulses may be defined as the number of pulses for the actuator to move the headlamp between the lowermost or uppermost position and a center portion of the head lamp in the vertical direction.

After the step d), the control unit may receive the driving signal of the vehicle and determine a target position of the head lamp in the horizontal direction or vertical direction by calculating a purse number corresponding to movement of the head lamp from the initial position to the target position, wherein the actuator is driven in a micro stepping manner by using the calculated pulse number, and wherein the target position is determined by the driving signal.

When a driving unit of the actuator is rotated to a mechanical stopper position at the step b), it may be verified as a still state in which the head lamp is determined to be moved to the rightmost or leftmost position, or the lowermost or uppermost position, by detecting a signal of a counter electromotive force generated from a terminal of a motor in the actuator.

The actuator may include a swing actuator to move the head lamp in the horizontal direction and a tilting actuator to move the head lamp in the vertical direction.

With the configuration of the method of controlling the adaptive head lamp, the control system is simplified by employing an open loop control system instead of a complicated closed-loop system, and the motor is driven in a micro stepping manner to secure the confidence. When the driving unit is positioned at a mechanical stopper which is in a stall state, the position of the head lamp can be verified by the method of detecting a counter electromotive force, thereby eliminating a separate sensor mounting.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating a head lamp of a prior art.

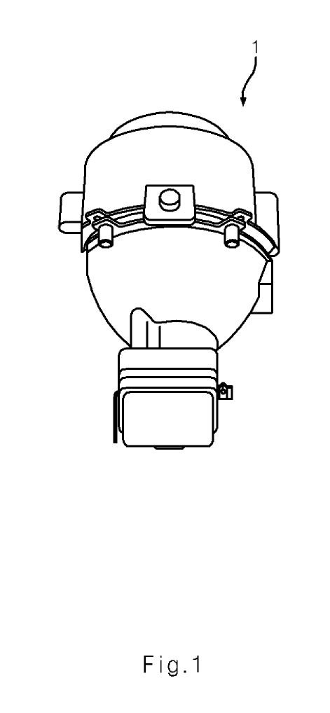

FIG. 2 is a perspective view illustrating an exemplary adaptive head lamp according to the present invention.

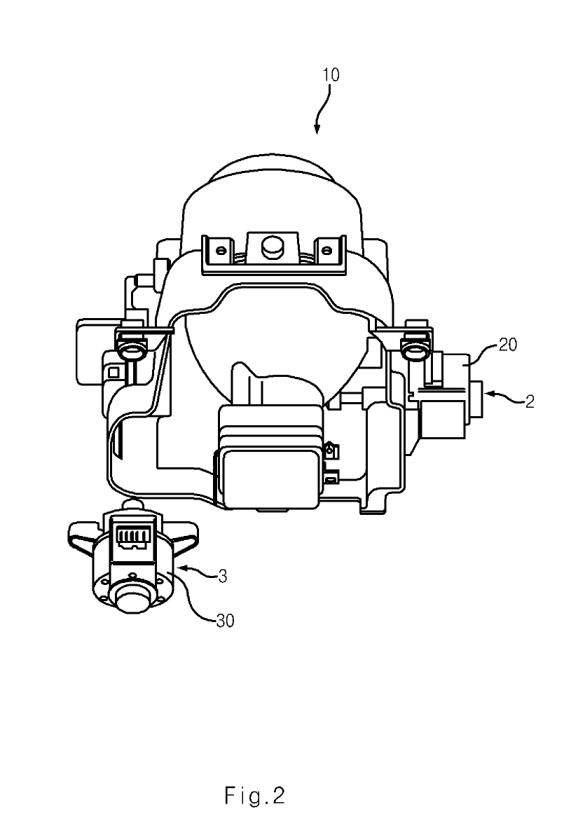

FIG. 3 is a flowchart illustrating a method of controlling initialization of an exemplary adaptive head lamp.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The configuration of an adaptive head lamp and a control method thereof according to an exemplary embodiment of the present invention will now be described in detail with reference to the accompanying drawings.

The adaptive head lamp according to an exemplary embodiment of the present invention includes a head lamp 10 which can be rotated in a horizontal or vertical direction, actuators 2 and 3 for supplying a driving force to the head lamp 10 to rotate the head lamp 10 in the horizontal or vertical direction, and a driving unit for transmitting the driving force from the actuator to the head lamp.

When the actuators 2 and 3 are controlled by the control unit, the control unit receives a steering angle signal and a velocity signal from the vehicle.

The control unit operates the steering angle signal to generate a driving signal for the actuator 3 which supplies a swing force, and operates the velocity signal of the vehicle for the actuator 2 which supplies a tilting force.

The control unit can send a micro stepping driving signal to the actuators 2 and 3, as well as a full-step driving signal, and can generate a driving signal corresponding to the number of pulses required for the actuators 2 and 3.

In addition, the control unit has a function of verifying a counter electromotive force generated from a terminal of the motors 20 and 30 in the actuators 2 and 3.

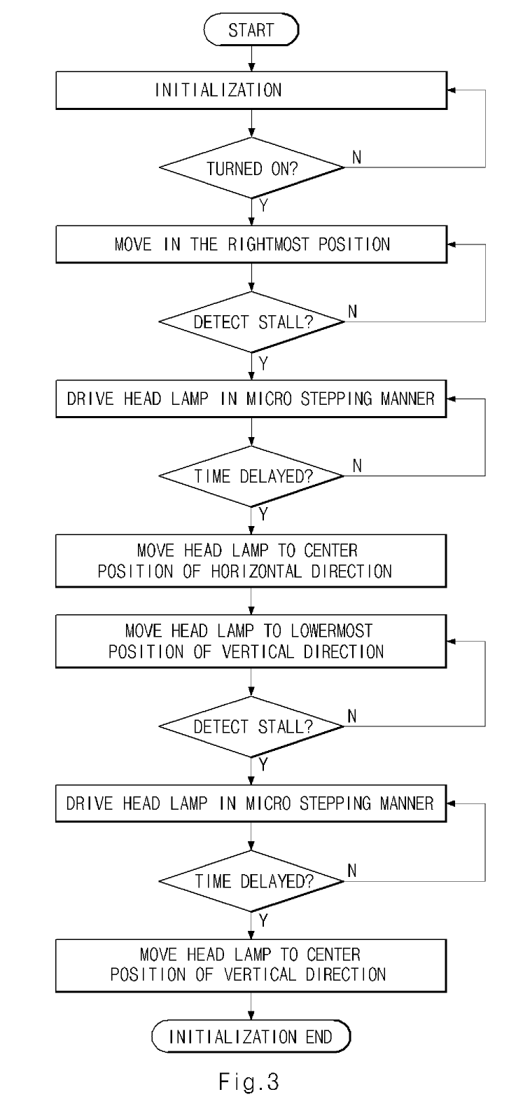

FIG. 3 is a flowchart illustrating a method of controlling the initialization of the adaptive head lamp.

In an exemplary embodiment of the present invention, if the driver turns on a power source to supply an electric power to the vehicle and thus turn on the ignition, it is verified whether the ignition is turned on prior to the initialization.

If it is verified that the ignition is turned on, the swing actuator 3 is driven to move the driving unit of the head lamp 10 in the rightmost direction. In this step, the control unit drives the swing actuator 3 in accordance with the full-step driving signal, and the swing actuator 3 receives the signal to allow the driving unit to rotate the head lamp 10 in the right direction.

If the head lamp 10 is rotated in the rightmost direction, that is, the driving unit reaches the rightmost position and thus is positioned at a mechanical stopper position, it is in a stall state in which the driving unit is not further rotated.

In the stall state, the counter electromotive force is generated from the terminal of the motor 30, and thus the signal is verified by the control unit. Then, the control unit does not send the full-step driving signal to the swing actuator 3.

Next, the swing actuator 3 is driven to move the head lamp 10 to a center position of the horizontal direction.

In this step, the control unit drives the swing actuator 3 in accordance with a micro stepping signal which rotates the swing actuator 3 in a left direction.

The control unit applies signals corresponding to the number of the pulses previously calculated which are required to move the swing actuator 3 to the center position of the horizontal direction, to the swing actuator 3.

After that, the current position is set to be at the center position (initial position) of the horizontal direction at a short interval.

If the initial position of the horizontal direction is set, the tilting actuator 2 is driven to move the head lamp 10 in the downstream direction.

In this step, the control unit drives the tilting actuator 2 in accordance with the full-step driving signal, and the tilting actuator 2 receives the signal to allow the driving unit to rotate the head lamp 10 in a downstream direction.

If the head lamp 10 is rotated to the lowermost position, that is, the driving unit reaches the lowermost position and thus is positioned at a mechanical stopper position, it is in a stall state in which the motor 20 is not further rotated.

In the stall state, the counter electromotive force is generated from the terminal of the motor 20, and thus the signal is verified by the control unit. Then, the control unit does not send the full-step driving signal to the tilting actuator 2.

Next, the tilting actuator 2 is driven to move the head lamp 10 to a center position of the vertical direction.

In this step, the control unit drives the tilting actuator 2 in accordance with a micro stepping signal which rotates the tilting actuator 2 in an upward direction.

The control unit applies signals corresponding to the number of the pulses previously calculated which are required to move the tilting actuator 2 to the center position of the vertical direction, to the tilting actuator 2.

After that, the current position is set to be at the center position (initial position) of the vertical direction at a short interval.

After the initial position set is completed, the control unit receives a driving information signal of the vehicle to calculate a target position of the horizontal direction or vertical direction of the head lamp.

After that, the control unit calculates a moving distance of the head lamp 10 which should be moved in the horizontal or vertical direction from the initial position (or current position) to the target position.

In order to do it, the control unit determines how many the number of the pulse signals is sent to each actuator.

The position of the head lamp 10 is moved to the target position in the micro stepping manner which applies the signals corresponding to the determined number of the pulses.

Since the control of the micro stepping manner has the accuracy 16 times higher than the full-step driving manner, it is possible to control the position with more accurate.

For convenience in explanation and accurate definition in the appended claims, the terms “upstream”, “downstream”, “rightmost” and “leftmost” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling an adaptive head lamp including a control unit for detecting a driving signal of a vehicle to control an actuator which controls the head lamp in a horizontal or vertical direction in accordance with a control signal of the control unit, including steps of:
a) verifying whether an ignition of the vehicle is turned on or off;
b) after the ignition of the vehicle is verified, driving the actuator to move the head lamp to a rightmost or leftmost position in the horizontal direction, or a lowermost or uppermost position in the vertical direction;
c) driving the actuator by a predetermined number of pulses previously set in a micro stepping manner in a direction opposite to a driving direction of the headlamp at the step b); and
d) setting a position of the head lamp determined at the step c) as an initial position.

2. The method of controlling the adaptive head lamp as claimed in claim 1, wherein the predetermined number of pulses is defined as the number of pulses for the actuator to move the headlamp between the rightmost or leftmost position and a center portion of the head lamp in the horizontal direction.

3. The method of controlling the adaptive head lamp as claimed in claim 1, wherein the predetermined number of pulses is defined as the number of pulses for the actuator to move the headlamp between the lowermost or uppermost position and a center portion of the head lamp in the vertical direction.

4. The method of controlling the adaptive head lamp as claimed in claim 1, wherein after the step d), the control unit receives the driving signal of the vehicle and determines a target position of the head lamp in the horizontal direction or vertical direction by calculating a purse number corresponding to movement of the head lamp from the initial position to the target position,
wherein the actuator is driven in a micro stepping manner by using the calculated pulse number, and
wherein the target position is determined by the driving signal.

5. The method of controlling the adaptive head lamp as claimed in claim 1, wherein when a driving unit of the actuator is rotated to a mechanical stopper position at the step b), it is verified as a still state in which the head lamp is determined to be moved to the rightmost or leftmost position, or the lowermost or uppermost position, by detecting a signal of a counter electromotive force generated from a terminal of a motor in the actuator.

6. The method of controlling the adaptive head lamp as claimed in claim 5, wherein after the step d), the control unit receives the driving signal of the vehicle and determines a target position of the head lamp in the horizontal direction or vertical direction by calculating a purse number corresponding to movement of the head lamp from the initial position to the target position,
wherein the actuator is driven in a micro stepping manner by using the calculated pulse number, and
wherein the target position is determined by the driving signal.

7. The method of controlling the adaptive head lamp as claimed in claim 1, wherein the actuator includes a swing actuator to move the head lamp in the horizontal direction and a tilting actuator to move the head lamp in the vertical direction.
